(19) United States
(12) Patent Application Publication
(10) Pub. No.: US 2021/0397682 A1
(43) Pub. Date: Dec. 23, 2021

(54) Secure Service Interaction

(71) Applicant: Alkira Software Holdings Pty Ltd., Queensland (AU)

(72) Inventor: Raymond James GUY, Doonan (AU)

(21) Appl. No.: 17/283,500

(22) PCT Filed: Sep. 24, 2019
(86) PCT No.: PCT/AU2019/051023

§ 371 Date: Apr. 7, 2021

(30) Foreign Application Priority Data
Oct. 8, 2018 (AU) 2018903786

(51) Int. Cl. G06F 21/31; G06F 3/16; G10L 17/00; G06F 21/60

(52) U.S. Cl. CPC G06F 21/31; G06F 21/602; G10L 17/00; G06F 3/167

(57) ABSTRACT

A system for allowing a user to interact with a secure service, the system including an interaction processing system including one or more electronic processing devices configured to receive security data from a user client device, the security data being usable to interact with the secure service and being encrypted using a passcode, store the security data, receive from a user interface system, on behalf of the user, an indication of a service interaction request, an access token indicative of the passcode, retrieve the security data using the access token and use the security data to interact with the secure service on behalf of the user and in accordance with the service interaction request.

### BACKGROUND OF THE INVENTION

The present invention relates to a method and system for facilitating user interaction with a secure service.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Speech based interfaces, such as Google's Home Assistant and Amazon's Alexa, are becoming more popular. However, it is currently very difficult to use these systems to interact with content that is normally presented by a computer system in a visual manner. For example, webpages are presented on a graphical user interface and therefore require users to be able to see and understand content and any available input options.

One solution to this problem involves using screen readers to read out content that is normally presented on the screen sequentially. However, this makes it difficult and time consuming for users to navigate to an appropriate location on a webpage, particular if the webpage includes a significant amount of content. Additionally, such solutions are unable to represent the content of graphics or images unless they have been appropriately tagged, resulting in much of the meaning of webpages being lost.

Attempts have been made to address such issues. For example, the Web Content Accessibility Guidelines (WCAG) define tags attributes that should be included in the websites to assist navigation tools, such as screen readers. However, the implementation required that these tags attributes are intrinsic to website design and must be implemented by web site authors. There are currently limited support for these from web templates and whilst these have been adopted by many governments, who can mandate their use, there has been limited adoption by business. This problem is further exacerbated by the fact that such accessibility is not of concern to most users or developers, and the associated design requirements tend to run contra to typical design aims, which are largely aesthetically focused.

WO2018/132863 describes a method for facilitating user interaction with content including, in a suitably programmed computer system, using a browser application to: obtain content code from a content server in accordance with a content address; and, construct an object model including a number of objects and each object having associated object content, and the object model being useable to allow the content to be displayed by the browser application; using an interface application to: obtain interface code from an speech server; obtain any required object content from the browser application; present a user interface to the user in accordance with the interface code and any required object content; determine at least one user input in response to presentation of the interface; and, generate a browser instruction in accordance with the user input and interface code; and, using the browser application to execute the browser instruction to thereby interact with the content.

A further issue that arises particularly with speech based platforms is that of security. Specifically, it is not generally secure to have a user audibly present security information, such as usernames or passwords, due to the risk this will be overheard, and due to the difficultly in adequately securing the data as it is provided for interpretation by backend systems.

### SUMMARY OF THE PRESENT INVENTION

In one broad form, an aspect of the present invention seeks to provide a system for allowing a user to interact with a secure service, the system including an interaction processing system including one or more electronic processing devices configured to: receive security data from a user client device, the security data being usable to interact with the secure service and being encrypted using a passcode; store the security data; receive from a user interface system, on behalf of the user, an indication of: a service interaction request; an access token indicative of the passcode; retrieve the security data using the access token; and use the security data to interact with the secure service on behalf of the user and in accordance with the service interaction request.

In one broad form, an aspect of the present invention seeks to provide a method for allowing a user to interact with a secure service, the method including, in an interaction processing system including one or more electronic processing devices: receiving security data from a user client device, the security data being usable to interact with the secure service and being encrypted using a passcode; store the security data; receiving from a user interface system, on behalf of the user, an indication of: a service interaction request; an access token indicative of the passcode; retrieving the security data using the access token; and using the security data to interact with the secure service on behalf of the user and in accordance with the service interaction request.

In one broad form, an aspect of the present invention seeks to provide a computer program product for allowing a user to interact with a secure service, the computer program product including computer executable code that when executed by a suitably programmed interaction processing system including one or more electronic processing devices, causes the interaction processing system to: receive security data from a user client device, the security data being usable to interact with the secure service and being encrypted using a passcode; store the security data; receive from a user interface system, on behalf of the user, an indication of: a service interaction request; an access token indicative of the passcode; retrieve the security data using the access token; and use the security data to interact with the secure service on behalf of the user and in accordance with the service interaction request.

In one embodiment the access token contains an encrypted version of the passcode.

In one embodiment the passcode is encrypted using an encryption key of the interaction system.

In one embodiment the access token is a modified OAuth token.

In one embodiment the interaction processing system is configured to: receive the passcode; use the passcode to generate the access token; and, transfer the access token to a user interface system.

In one embodiment the interface system is configured to associate the access token with a user identity and wherein the user interface system is configured to: determine a user identity; and, retrieve the access token using the user identity.

In one embodiment the interface system is configured to associate the access token with an interface system user account linked to the interaction system user account.

In one embodiment the interaction processing system is configured to receive the passcode from an account linking device used to link the interaction system and interface system user accounts.

In one embodiment the passcode is provided to the account linking device from the client device during an account linking process.

In one embodiment the client device is configured to: determine using user input commands: the security data; and, the passcode; encrypt the security data using the passcode; and, provide the encrypted security data to the interaction processing system.

In one embodiment, in response to receiving the service interaction request, the interaction processing system is configured to: authenticate the user to validate a user identity of the user; and, retrieve the security data in response to successful validation.

In one embodiment the interaction processing device is configured to: request secondary security data from the user via the user client device; and, access the secure service at least in part using the secondary security data.

In one embodiment the user interface system includes a speech processing system that is configured to: generate speech interface data; provide the speech interface data to a speech enabled client device, wherein the speech enabled client device is configured to be responsive to the speech interface data to: generate audible speech output indicative of a speech interface; detect audible speech inputs indicative of a user input; and, generate speech input data indicative of the speech inputs; receive speech input data; and, use the speech input data to at least one of: identify a user; and, determine a service interaction request from the user.

In one embodiment: the speech processing system is configured to: interpret the speech input data to identify a input; generate input data indicative of the input; the interaction processing system is configured to: obtain the input data; use the input data to identify a content interaction; and, perform the content interaction.

In one embodiment: the interaction processing system is configured to: obtain content code from a content processing system in accordance with a content address, the content code representing content that can be displayed; obtain interface code from an interface processing system at least partially in accordance with the content address, the interface code being indicative of an interface structure; construct a speech interface by populating the interface structure using content obtained from the content code; generate interface data indicative of the speech interface; the speech processing system is configured to: receive the interface data; and, generate the speech interface data using the interface data.

In one embodiment the security data includes at least one of: a username; a password; payment details; and, account details.

In one embodiment the secure service is accessed at least one of: via a website; via an interface to a web service; and, via a third party system.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which:

FIG. 1 is flow chart of an example of a process for allowing a user to interact with a secure service;

FIG. 2 is a schematic diagram of an example distributed computer architecture;

FIG. 3 is a schematic diagram of an example of processing system;

FIG. 4 is a schematic diagram of an example of a client device;

FIG. 5 is a schematic diagram illustrating the functional arrangement of a system for allowing a user to interact with a secure service;

FIGS. 6A and 6B is a flow chart of an example of a process for performing a user interaction with content;

FIGS. 7A and 7B are a flow chart of a process for configuring a system to allow a user to interact with a secure service;

FIGS. 8A and 8B are a flow chart of an example of a process for interacting with a secure service;

FIG. 9 is a schematic diagram illustrating an account linking process; and,

FIG. 10 is a schematic diagram illustrating a process for interacting with a secure service.

### DETAILED DESCRIPTION OF THE PREFERRED EMBODIMENTS

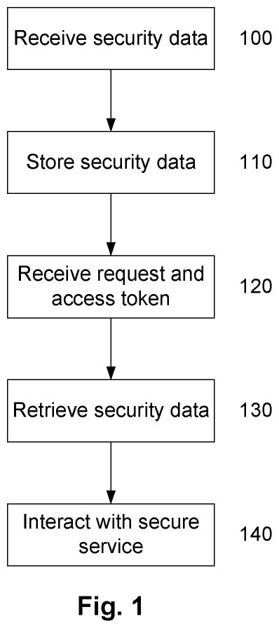

An example of a process for allowing a user to interact with a secure service will now be described with reference to FIG. 1.

For the purpose of illustration, it is assumed that the process is performed at least in part using one or more electronic processing devices forming part of one or more processing systems, such as computer systems, servers, or the like, which are in turn connected to other processing systems and one or more client devices, such as mobile phones, portable computers, tablets, or the like, via a network architecture, as will be described in more detail below.

For the purpose of this example, it is assumed that the process is implemented using a suitably programmed interaction processing system that is capable of retrieving and interacting with content hosted by a remote content processing system, such as a content server, or more typically a web server. The interaction processing system can be a traditional computer system, such as a personal computer or laptop, could be a server, or could include any device capable of retrieving and interacting with content, and the term should therefore be considered to include any such device, system or arrangement.

For the purpose of this example, it is assumed that the interaction processing system, includes one or more electronic processing devices, and is capable of executing one or more software applications, such as a browser application and an interface application, which in one example could be implemented as a plug-in to the browser application. The browser application mimics at least some of the functionality of a traditional web browser, which generally includes retrieving and allowing interaction with a webpage, whilst the interface application is used to create a user interface. Whilst the browser and interface applications can be considered as separate entities, this is not essential, and in practice the browser and interface applications, could be implemented as a single unified application. Furthermore, for ease of illustration the remaining description will refer to a processing device, but it will be appreciated that multiple processing devices could be used, with processing distributed between the devices as needed, and that reference to the singular encompasses the plural arrangement and vice versa.

It is also assumed that the interaction processing system is capable of interacting with a user interface system that is capable of presenting the interface generated by the interface application. In one example, the interface system includes a speech enabled client device, such as a virtual assistant, which can present audible speech output and receive audible speech inputs, and an associated speech processing system, such as a speech server, which interprets audible speech inputs and provides the speech enabled client device with speech data to allow the audible speech output to be generated. It will be appreciated that the virtual assistant could include a hardware device, such as an Amazon Echo or Google Home speaker and/or associated cloud based services, or could be implemented as software running on a hardware device, such as a smartphone, tablet, computer system or similar. It will be appreciated from the following however, that this is not essential and other interface arrangements, such as the use of a stand-alone computer system, could also be used.

In this example, in order to perform interactions with a secure service, two different phases of operation are shown, including configuring the system to allow for subsequent access to a secure service, as set out in steps 100 and 110 and utilising the system to interact with a secure service, as shown in steps 120 to 140. It will be appreciated that the process of configuring the system may only need to be performed a single time in order to allow multiple subsequent interactions. Thus, steps 100 and 110 can be performed once to allowing a user to access a given secure service, with steps 120 to 140 occurring repeatedly as needed, in order to allow multiple interactions to be performed. However, this is not essential, and other arrangements are contemplated, such as performing each of steps 100 to 140 each time an interaction is required.

In this example, at step 100, security data is received from a user client device, with the security data being usable to interact with the secure service. The nature of the security data will vary depending upon the requirements of the secure service and could include a username and password, payment information, such as credit card details, user preferences, or other similar security data. The manner in which this is received will vary depending upon the preferred implementation, but in one example, this information is input using a client device, for example by entering the information via a graphical user interface presented by an App or browser application, with the security data being encrypted prior to transfer to the one or more electronic processing devices. The security data is encrypted utilising a passcode, such as a (Personal Identification Number) PIN, alpha-numeric code, or similar.

At step 110, the processing device stores the security data.

Having undergone the set up phase in steps 100 and 110, the process can then be used to provide access to the service. To achieve this, at step 120 the interaction processing system receives an indication of a service interaction request and the access token, from the user interface system. This is typically performed in response to a user request, for example, by having the user make an audible request via the interface system.

The service interaction request is typically indicative of the secure service the user wishes to access, and typically includes enough detail to allow the secure service to be identified. Thus, the service interaction request could include an indication of a type of service and an identify of a specific host, for example identifying that the user wishes to access internet banking services associated with a respective financial institution, or could include reference to a specific website, such as by identifying a Universal Resource Locator (URL) or similar.

The access token is used to allow the security data to be retrieved and is typically indicative of the passcode, allowing the passcode to be used to decrypt the encrypted security data. The form of access token, and how this is used will vary depending upon the preferred implementation. In one particular example, the access token is a credential that can be used by an application to access an API, and could include an opaque string or a JSON (JavaScript Object Notation) Web Token. The purpose of the access token is to inform the recipient that the bearer of this token has been authorized to access the API and perform specific actions. The access token is typically provided as a bearer credential and transmitted in an HTTP (Hypertext Transfer Protocol) authorization header to the API. In one particular example, the access token is a modified OAuth token, and in particular is an enhanced OAuth token including an encrypted version of the passcode in a payload. However, it will also be appreciated that the term access token is intended to be interpreted broadly and could refer to any token or other similar credential that can be used to provide permission to access information.

The access token is generated by the interaction processing device in a separate configuration process, and can then be made available to the user interface system, for example by transferring this to the user interface system. It should be noted that in a preferred example, no other system stores the modified authorization token containing the encrypted passcode, and this is only retained by the interface system, thereby precluding the modified token being accessed by other third parties, which in turn helps maintain security of the passcode. Whilst other systems may (or may not) store an unmodified version of the authorisation token, which does not include the passcode, it will be appreciated that this would not provide access to the security data. As an alternative however, it will be appreciated that the modified token may be stored in alternative locations and retrieved on an as need basis.

The indication of the access token could include the physical access token, or could identify the access token in a manner allowing this to be retrieved, for example by identifying a storage location of the token.

Having obtained the passcode from the access token, the interaction processing system retrieves the security data at step 130, using the passcode to decrypt the security data as needed. The interaction processing system can then use the security data at step 140 to interact with the secure service on behalf of the user, for example, allowing the interaction to undergo security checks, such as logging on to an account of the user, enabling the interaction processing system to act on the user's behalf

Accordingly, in one particular example, the above described process allows a user to upload security data, such as a username and password, or other login details, with these being securely stored until it is needed to access a secure service. The security data is accessed using an access token, which can be provided to a third party, such as an operator of a user interface system. In this instance, when the user wishes to use the interface system to interact with the secure service, the user can establish an interaction request via the user interface system, allowing the user interface system to retrieve the access token and forward this, together with the interaction request, to the interaction processing system. The interaction processing system can then retrieve the security data and use that to interact with the secure service, for example, allowing the interaction processing system to populate a login webpage with relevant login details, and thereby access the relevant service on the user's behalf

Accordingly, the above described process enables a user to store security data with a trusted operator of the interaction processing system enabling the security data to be used to access secure services on their behalf This in turn allows the user to access secure services via a user interface system, such as a voice assistant, without the need to provide security data, such as usernames or passwords, or other login details, to the user interface system. This is particularly important, as the security of user interface systems is typically limited and this therefore avoids the need for the user to provide security data via untrusted communications.

A number of further features will now be described.

In one example, the interaction processing system generates the access token using the passcode. In particular, in one example, the passcode is a PIN, which is used together with an encryption algorithm to encrypt the security data. In a separate step, the access token is generated using the passcode, typically by having the access token store an encrypted version of the passcode in a payload. In one preferred approach, this can be achieved by encrypting the passcode using a public key of a public/private key pair associated with the interaction processing system, so that the passcode can only be decrypted using the secret key. As the secret key is only available to the interaction processing system, this means the access token can be distributed freely, without third parties being able to access and decrypt the passcode. Storing the passcode in this manner, further avoids the need for the passcode to be stored locally within the interaction processing system, meaning the security data can only be accessed using the access token.

The nature of the access token could be of any appropriate form, but as mentioned above, in one example is a modified OAuth token, and in particular is an enhanced OAuth token modified to include a payload containing the encrypted passcode.

The passcode can be determined in any appropriate manner and could be generated by the processing device. More typically however, the passcode is provided by the user via the user client device. This ensures the passcode is selected by the user, meaning the passcode is memorable for them, allowing the user to enter the passcode and hence gain access to the security data, for example allowing them to alter or delete this as needed.

The interaction system obtains the passcode and uses this to generate the access token. Having created the access token , the interaction processing system can transfer the access token to the user interface system. In this regard, providing the access token to the user interface system allows the user interface system to then return the access token to the interaction processing system when an interaction is to be requested. It will be appreciated however that this is not necessarily essential, and alternatively the access token could be retrieved from a third party database or system.

In general, the user interface system must be able to retrieve the access token associated with the respective user. To facilitate this process, the interface processing system can associate the access token with a user identity of the user, allowing the user interface system to determine the user identity of the user, and use this to retrieve the access token. Thus, in this scenario, the access token is associated with a particular user and can only be retrieved once the user has been identified, thereby preventing third parties attempting to fraudulently access the secure service.

Associating the access token with the identity of the user could be achieved in any appropriate manner, but in one example, this involves having the interface processing system associate the access token with an interface system user account. In this instance, the interface system can determine the user identity of the user and use this to access the interface system user account, and hence retrieve the access token. Thus, the interface system can determine the user identity, for example based on a voice recognition process and/or the use of a particular speech enabled client device, and use this to access a user account and retrieve the access token.

In one particular example, the interaction processing system also maintains a separate interface system user account. In this example, the user can link their interface system user account and interaction system user account, typically by interacting with an account linking device, which could form part of or be related to the user interface system, and requesting that the user interface account is linked to the interaction system account. For example, this process could be performed via a separate server associated with the entity providing the user interface system. This can be performed in accordance with established linking protocols and will not therefore be described in further detail. In general, the passcode is provided as part of this process, and passed on to the interaction processing system, allowing this to generate the modified access token and provided this to the interface system, allowing the user interface system to retrieve the access token as needed.

Once the access token is generated, the user can establish the security data. In one example, the client device determines the security data and the passcode using user input commands, and then encrypts the security data using the passcode and provides the encrypted security data to the interaction processing system. This allows the interaction processing system to store the encrypted security data, allowing it to be subsequently retrieved using the access token. Having the encrypted security data generated by the client device, also prevents the need for the interaction processing system to have access to the passcode when setting up the system. This means the user only ever provides the passcode when initially linking the accounts, helping to maintain security of the passcode.

In order to provide an additional level of security, in one example, the system performs additional validation of the user identity. In one example, this can be performed by the interaction processing device, so that the user is in effect undergoing two stage authentication. Such validation of the user identity could be performed in any appropriate manner, and could for example include prompting the user to enter their passcode or PIN via the user client device. Thus, for example, upon receiving the service interaction request, the interaction processing device could access the account of the user, and identify a nominated authentication process. The interaction processing device could then generate any necessary challenge, and provide this to a nominated user client device, allowing the user to generate a challenge response, and thereby confirm their identity. Such two factor authentication processes are known and will not therefore be described in any further detail.

It will be appreciated that such secondary authentication and validation introduces an additional burden on the user, and in one example, requires the user to be able to access a client device. Accordingly, in one example, such additional authentication is only performed in limited circumstances, depending on the security requirements of the secure service. For example, if the secure service includes internet banking, the user might be able to perform basic transactions, such as viewing a balance or transferring funds between their own accounts, without requiring additional authentication, but that to make payments to third parties, additional authentication may be required.

Similarly, it may be necessary to capture additional information, such as secondary security data, outside of the primary interface session. This might be required, because some information, such as CVV (Card Verification Value) numbers, cannot legally be stored. Accordingly, in this case, the interaction processing device may request information be captured via the user client device, allowing this to be used in accessing the secure service. Such data capture could be performed in any appropriate manner, and could for example include prompting the user to enter the user information via the user client device. Thus, for example, upon receiving a client-side data capture request, the interaction processing device could access the account of the user, and identify a nominated user client device, allowing the user to enter requested information. For example, if the secure service includes an online credit card payment, the user might be required to enter a CVV (Card Verification Value) on their mobile phone prior to resuming their interface session. It will be appreciated that multiple pieces of information may also be requested from the user client device, and that the user client device may also execute intricate workflow logic as part of a user client device data capture request.

In one particular example, the user interface system includes a speech processing system that generates speech interface data and provides the speech interface data to a speech enabled client device. The speech enabled client device is responsive to the speech interface data to generate audible speech output indicative of a speech interface, detect audible speech inputs indicative of a user input, such as a user response, and then generate speech input data indicative of the speech inputs.

The speech processing system then receives the speech input data from the speech enabled client device and uses the speech input data to identify a user and/or determine a service interaction request from the user. For example, this typically includes interpreting the users recorded speech into text, and then understanding from the text the request the user is making.

Accordingly, it will be appreciated that in one particular embodiment, the above described arrangement represents a virtual assistant, which includes a speech enabled client device, such as Google Home Assistant, and Amazon Echo device or similar, which interacts with a speech processing system, such as a Google or Amazon server, which in turn interprets inputs spoken by the user, and generates speech data, which is used to generate speech output.

In the above described arrangement, the interaction processing system typically operates to generate an interface, which can then be presented via the user interface system. In order to do this, the interaction processing system obtains content code from a content processing system in accordance with a content address, with the content code representing content that can be displayed. The nature of the content, the content code and the content address will vary depending on the preferred implementation. In one example, the content is a webpage, with the content code being HTML (HyperText Markup Language) or another similar code and the content address being a URL (Universal Resource Locator) or the like. It will be appreciated that in one example, the content relates to a secure service, such as a homepage of a banking website or similar.

The interaction processing system further obtains interface code, at least partially in accordance with the content address, with the interface code being indicative of an interface structure. The interface code is separate to the content code and used to allow the content code to be interpreted. The interface code is typically retrieved from a database in accordance with the content address and can be utilised in order to allow an interface to be presented to the user to allow the user to interact with the content. The interface code could be of any appropriate form but generally includes a mark-up language file including instructions that can be interpreted by the interface application to allow the interface to be presented. The interface code is typically developed based on an understanding of the content embodied by the content code, and the manner in which users interact with the content and can be created using manual and/or automated processes. The interface code allows the interaction processing system to construct a speech interface by populating the interface structure using content obtained from the content code. This results in the interaction processing system generating interface data, which is indicative of a speech interface.

The interface data can then be provided to the speech processing system, which receives the interface data and uses this to generate the speech interface data, specifically by generating speech statements, which can be presented by a speech enabled client device to present an audible speech output indicative of the content and structure of the user interface.

The speech processing system also typically interprets speech input data received from the speech enabled client device, in response to detection of audible speech inputs indicative of a user input. The speech processing device interprets the speech input data to identify one or more inputs corresponding to user inputs. Input data is generated indicative of the inputs, with this being provided to the interaction processing system, enabling the interaction processing system to use the input data to identify content interaction and then perform the content interaction.

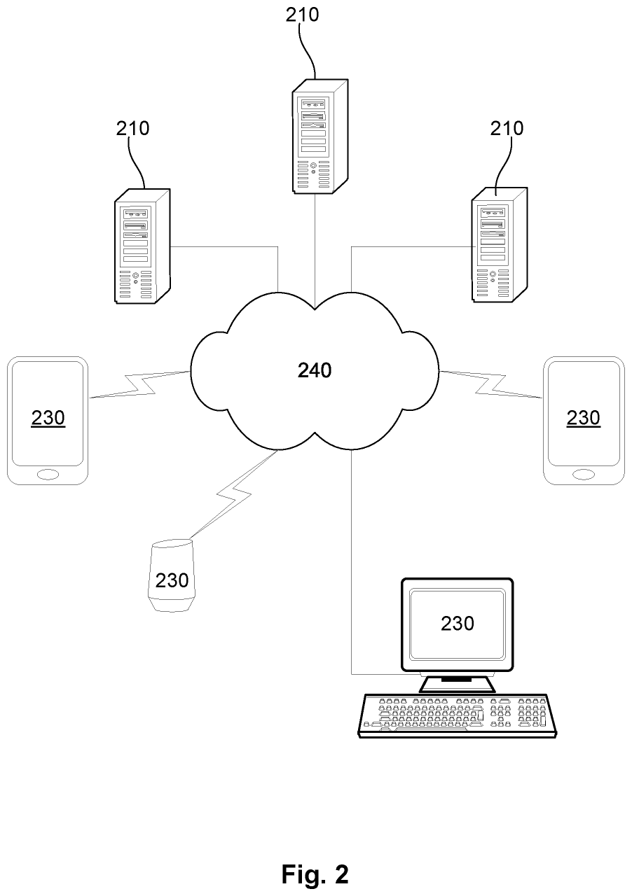

As mentioned above, in one example, the process is performed by one or more computer systems operating as part of a distributed architecture, an example of which will now be described with reference to FIG. 2.

In this example, a number of processing systems 210 are provided coupled to one or more client devices 230, via one or more communications networks 240, such as the Internet, and/or a number of local area networks (LANs).

Any number of processing systems 210 and client devices 230 could be provided, and the current representation is for the purpose of illustration only. The configuration of the networks 240 is also for the purpose of example only, and in practice the processing systems 210 and client devices 230 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In this example, the processing systems 210 are adapted to provide access to content and/or to interpret speech input provided via a speech enabled client device 230. Whilst the processing systems 210 are shown as single entities, it will be appreciated they could include a number of processing systems distributed over a number of geographically separate locations, for example as part of a cloud-based environment. Thus, the above described arrangements are not essential and other suitable configurations could be used.

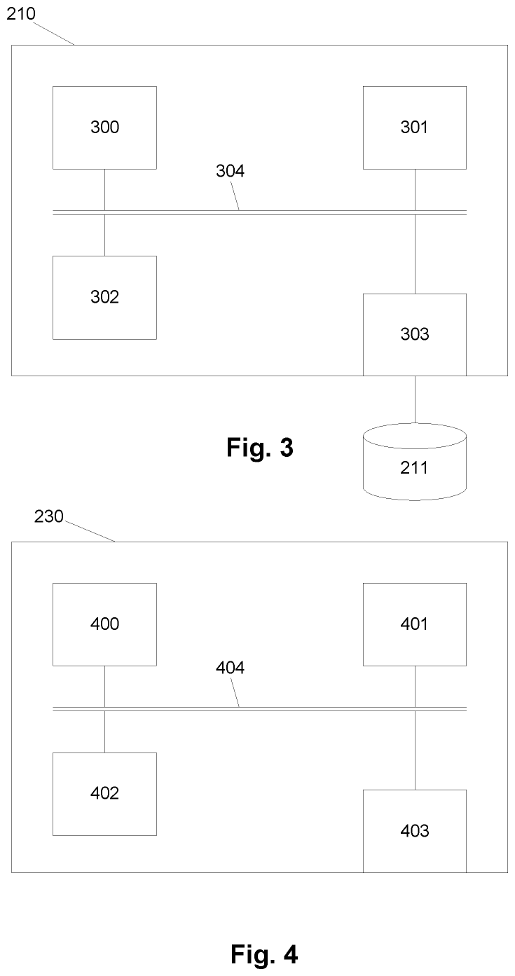

An example of a suitable processing system 210 is shown in FIG. 3. In this example, the processing system 210 includes at least one microprocessor 300, a memory 301, an optional input/output device 302, such as a keyboard and/or display, and an external interface 303, interconnected via a bus 304 as shown. In this example the external interface 303 can be utilised for connecting the processing system 210 to peripheral devices, such as the communications networks 240, databases 211, other storage devices, or the like. Although a single external interface 303 is shown, this is for the purpose of example only, and in practice multiple interfaces using various methods (eg. Ethernet, serial, USB, wireless or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like.

Accordingly, it will be appreciated that the processing systems 210 may be formed from any suitable processing system, such as a suitably programmed PC, web server, network server, or the like. In one particular example, the processing system 210 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, a client device 230 includes at least one microprocessor 400, a memory 401, an input/output device 402, such as a keyboard and/or display and an external interface 403, interconnected via a bus 404 as shown. In this example the external interface 403 can be utilised for connecting the client device 230 to peripheral devices, such as the communications networks 240, databases, other storage devices, or the like. Although a single external interface 403 is shown, this is for the purpose of example only, and in practice multiple interfaces using various methods (eg. Ethernet, serial, USB, wireless or the like) may be provided.

In use, the microprocessor 400 executes instructions in the form of applications software stored in the memory 401, to allow relevant processes to be performed, including allowing communication with one of the processing systems 210, and/or to generate audible speech output or detect audible speech input, in the case of a speech enabled client device.

Accordingly, it will be appreciated that the client device 230 be formed from any suitably programmed processing system and could include suitably programmed PCs, Internet terminal, lap-top, or hand-held PC, a tablet, a smart phone, or the like. However, it will also be understood that the client device 230 can be any electronic processing device such as a microprocessor, microchip processor, logic gate configuration, firmware optionally associated with implementing logic such as an FPGA (Field Programmable Gate Array), or any other electronic device, system or arrangement.

Examples of the processes for presenting and interacting with content, including providing access to secure services, will now be described in further detail. For the purpose of these examples it is assumed that one or more respective processing systems 210 are servers (and will hereinafter be referred to as servers), and that the servers 210 typically execute processing device software, allowing relevant actions to be performed, with actions performed by the server 210 being performed by the processor 300 in accordance with instructions stored as applications software in the memory 301 and/or input inputs received from a user via the I/O device 302. It will also be assumed that actions performed by the client devices 230, are performed by the processor 400 in accordance with instructions stored as applications software in the memory 401 and/or input inputs received from a user via the I/O device 402.

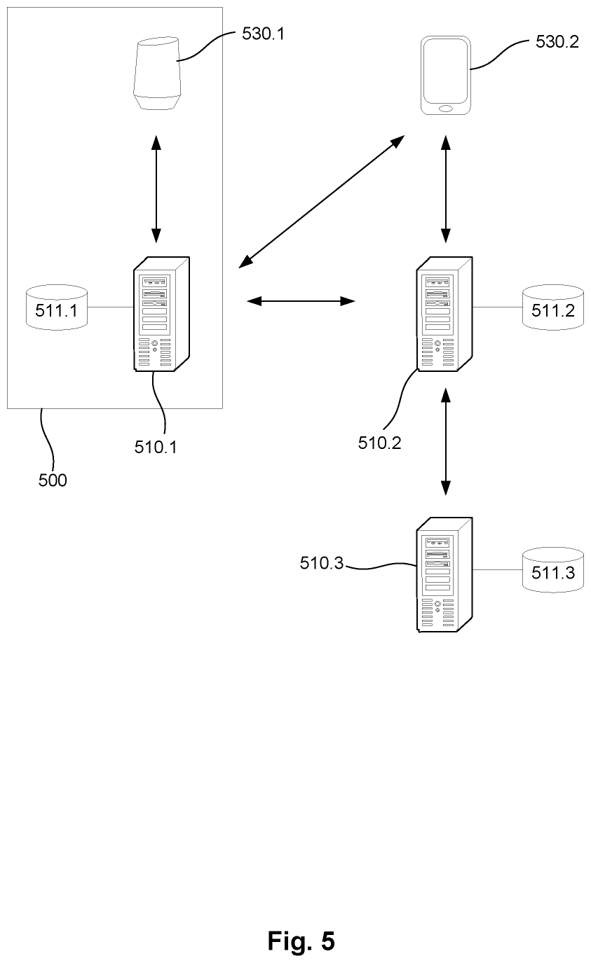

Typically, different types of server are provided to provide the required functionality, and an example of a functional arrangement of the above described system will now be described with reference to FIG. 5.

In this example, the system includes a user interface system 500, including a speech enabled client device 530.1, which interacts with a speech server 510.1, allowing the speech server 510.1 to interpret spoken inputs provided by a user and allowing the speech server 510.1 to generate speech data, which can then be used by the speech enabled client device 530.1 to generate audible speech output. The user interface system 500 also typically includes a speech database 511.1, which is used to store interface system user accounts, access tokens, and other information required to perform the necessary speech processing.

In this example, an interaction server 510.2 is provided, which is able to communicate with the speech server 510.1, to receive input data indicative of user input inputs and to allow generated interface data to be provided, to enable the user interface system 500 to present a user interface. The interaction server 510.2 is connected to an interaction database 511.2, which stores details of interaction system user accounts and interface code, used to interpret content code, and generate interfaces.

The interaction server 510.2 is also in communication with a second user client device 530.2, which allows the user to interact directly with the interaction processing system 510.2 via an app or other suitable mechanism, and a content server 510.3, such as a web server, to allow content code to be retrieved from a content database 511.3, and provided to the interaction server 510.2 as needed.

However, it will be appreciated that the above described configuration assumed for the purpose of the following examples is not essential, and numerous other configurations may be used. It will also be appreciated that the partitioning of functionality between the different processing systems may vary, depending on the particular implementation.

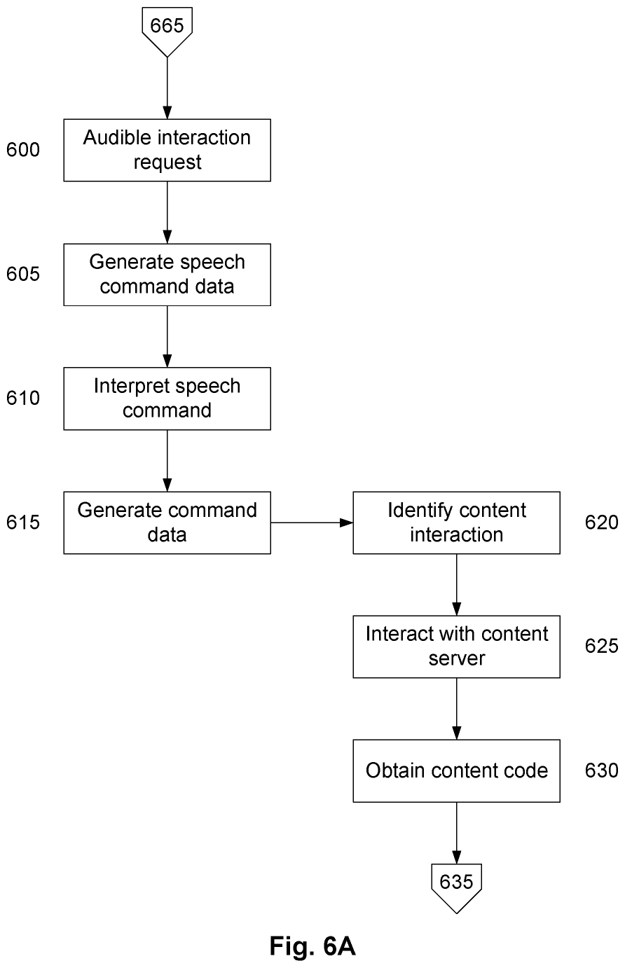

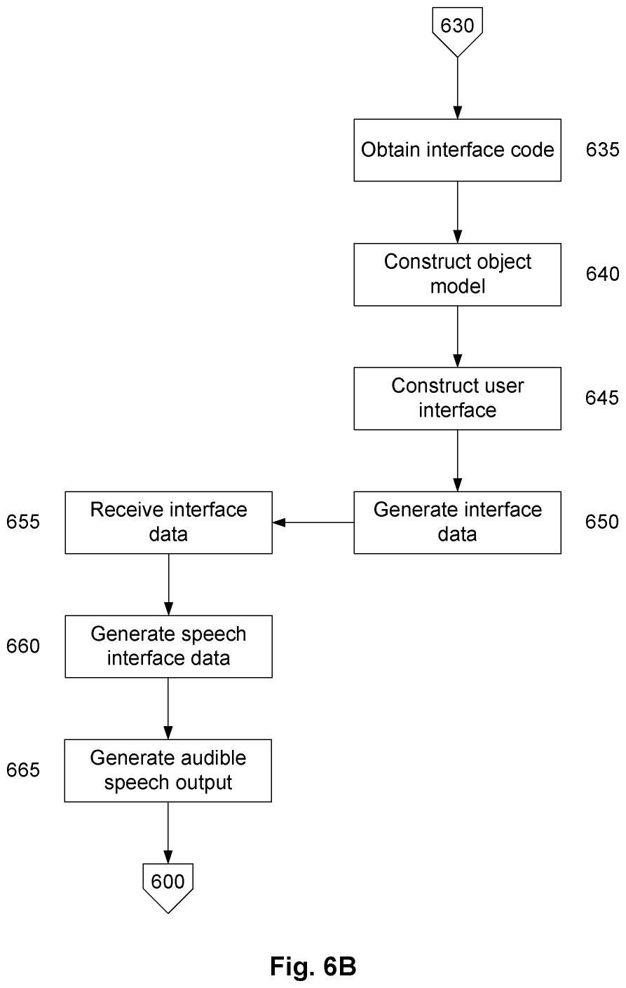

An example of an audible interaction process will now be described with reference to FIGS. 6A and 6B.

In this example, at step 600, a user provides an audible speech input, typically in the form of interaction request, which is achieved by speaking to the speech enabled client device 530.1. The interaction request could specify a service to be accessed, or including details of a URL or other address, to allow relevant content associated with the interaction to be retrieved. The speech enabled client device 530.1 generates speech input data at step 605, which is then uploaded to the speech sever 510.1, allowing the speech server 510.1 to interpret the speech input data and identify the speech input at step 610.

In particular, the speech server 510.1 will typically execute a local software application, provided by the interaction server 510.2, which provides instructions to the speech server 510.1 regarding how speech input relevant to the interaction server 510.2 should be interpreted. For example, the user might speak a input of the form “<Trigger phrase>, tell the interaction server to access my bank account”. The trigger phrase is used to instruct the speech server 510.1 to interpret the following speech as a input. The “tell the interaction server” statement, instructs the speech server 510.1 to launch an application provided by the interaction server 510.2 to assist with interpreting any spoken inputs. The “to access my bank account” is interpreted as a input to be provided to the interaction server 510.2.

Accordingly, at step 615, the speech server 510.1 generates input data indicative of the speech input, in this case “access my bank account”, transferring this to the interaction server 510.2, allowing the interaction server 510.2 to identify content interaction that is required at step 620.

It will be appreciated that the above described steps are largely standard steps associated with the operation of virtual assistants, and this will not therefore be described in any further detail.

The content interaction can be of any appropriate form, and could include entering text or other information, selecting content, selecting active elements, such as input buttons, or hyperlinks, or the like. Typically as part of this process, the interaction server 510.2 uploads information to the content server 510.3 at step 625, allowing the content server 510.3 to take any necessary action and then provide content code at step 630. For example, if the input includes a webpage URL, or selection of a hyperlink, the content server 510.3, would use this to retrieve the relevant content code. However, alternatively, if the interaction includes form completion, the content server 510.3 might need to update a webpage to represent entered information, providing content code indicative of the updated webpage.

In one example, the action needed might be wholly specified by the input. However, in other examples, interpretation may be required. So, in the current example of providing access to a user's bank account, the interaction server 510.2 might need to access a interaction system user account and identify the relevant banking webpage associated with the user's bank account, before requesting the banking portal website code from the relevant banking web server. Once a request has been made, the content server 510.3 typically returns content code such as HTML code, to the speech server 510.2.

Simultaneously with this, at step 635, interface code is obtained by the interaction server 510.2, typically by retrieving this from the interaction database 511.2, using the content address. The interface code and content code can then be used to construct a user interface, typically by populating an interface structure with content obtained from the content code.

In particular, at step 640, the interaction server 510.2 uses an internal browser application to construct an object model indicative of the content, from the content code. The object model typically includes a number of objects, each having associated object content, with the object model being usable to allow the content to be displayed by the browser application. In normal circumstances, the object model is used by a browser application in order to construct and subsequently render the webpage as part of a graphical user interface (GUI), although this step is not required in the current method. From this, it will be appreciated that the object model could include a DOM (Document Object Model), which is typically created by parsing the received content code.

Following this, the interaction server 510.2, extracts any required object content needed to present the interface using the object. In this regard, the required object content is typically specified by the interface code, so that the speech server 510.2 can use this information to extract the relevant object content from object model and use these to generate a user interface at step 645, typically by populating fields within the interface code with the object content.

In one example, the above processes are performed by having the interaction server 510.2 execute a browser application to retrieve the content and generate the object model, whilst an interface application is used to obtain the object code and populate an interface structure and thereby generate the interface. However, it will also be appreciated that this is not essential and alternative approaches could be used. The user interface is typically indicative of at least some of the object content and/or one or more available user inputs, thereby allowing content to be presented to the user and/or appropriate user inputs to be provided by the user. The user interface is typically simplistically designed and generally includes a single question or piece of information which is then presented together with one or more available response options, to thereby simplify the process of interacting with the content. In particular, this allows the user to interact with the content entirely non-visually.

At step 650, the interaction server 510.2 uses the user interface to generate interface data, which is uploaded to the speech server 510.1 at step 655. In this regard, the interface data typically specifies the content of the user interface to be presented, and may include additional presentation information specifying how the content should be presented, for example to include details of emphasis, required pauses, or the like. In one example, this can be achieved using style sheets associated with the content data.

This allows the speech server 510.1 to generate speech interface data at step 660, which is then uploaded to the speech enabled client device 530.1, allowing this to generate audible speech output at step 665. Again, this is performed in accordance with normal processes of the user interface system 500, and this will not therefore be described in any further detail.

The process can then return to step 600, allowing the user to provide an audible response, with this process being repeated as required. For example, the user input could specify the selection of a presented user interface option, which may in turn cause further content to be retrieved and presented. Additionally, and/or alternatively, other interactions could be performed, such as entering text or other information. In general, even for responses of this form, similar steps might be required, for example, uploading entered information to the content server 510.3, allowing the webpage to be updated, and any associated actions taken.

Accordingly, it will be appreciated that the above described process allows speech interaction with a website to be performed. To operate effectively, the simplified interface typically displays a limited amount content corresponding to a subset of the total content and/or potential interactions that can be performed based on the content code. This allows this the interface to be vastly simplified, making this easier to navigate and interact with the content in a manner which can be readily understood. This approach also allows multiple interfaces to be presented in a sequence which represents a typical task workflow with the webpage, allowing a user to more rapidly achieve a desired outcome, whilst avoiding the need for the user to be presented with superfluous information.

The interface is presented using separate interface code, additional to the content code, meaning that the original content code can remain unchanged. Furthermore, all interaction with the content server is achieved using standard techniques and in one example, can be performed using a browser application, meaning from the perspective of the content server there is no change in the process of serving content. This means the system can be easily deployed without requiring changes to existing content code or website processes.

Furthermore, the interface also operates to receive user speech inputs, interpret these and generate control instructions to control content interactions. Thus, it will be appreciated that the interface acts as both an input and output for content interactions, so that the user need only interact with the user interface system. As the interfaces can be presented in a strictly controlled manner, this provides a familiar environment for users, making it easier for users to navigate and digest content, whilst allowing content from a wide range of disparate sources to be presented in a consistent manner.

A number of further features associated with the above described process will now be described.

In one example, the user interface typically includes a plurality of interface pages wherein the method includes presenting a number of interface pages in a sequence in order to allow tasks to be performed. Thus, interface pages can be utilised in order to ascertain what task the user wishes to perform and then break down that task into a sequence of more easily performed interactions, thereby simplifying the process of completing the task.

The process of presenting the sequence of interface pages is typically achieved by presenting an interface page, determining at least one user input in response to the presented interface page, selecting a next interface page at least partially in accordance with the user input and then presenting the next page, allowing this process to be repeated as needed until desired interactions have been performed. The sequence of interface pages is typically defined in the interface code, for example by specifying which interface page should be presented based on the previous displayed page and a selected response. In this manner, a workflow to implement tasks can be embodied within the interface code, meaning it is not necessary for the user to have any prior knowledge of the website structure in order to perform tasks.

Whilst the interface pages can be defined wholly within the interface code, typically at least some of the interface pages will present a portion of the content, such as a particular part of the website. In order to ensure that the correct content is retrieved and displayed, the required content is specified within the interface code. As content can be dynamic or change over time, the content is typically defined in a manner which allows this to be reliably retrieved, in particular by specifying the object from which content should be obtained. Accordingly, when an interface page is to be displayed, the method typically includes having the interface application determine required object content for the next interface page in accordance with the interface code, obtain the required object content and then generate the next user interface page using the required object content.

In one particular example, the process of retrieving content typically involves having the interface application determine required object content using the interface code, generate an object request indicative of the required object content and provide the object request to the browser application. In this instance, a browser application receives the object request, determines the required object content, typically from the constructed object model, generating an object content response indicative of the required object content and then providing the object content response to the interface application.

It will be appreciated that as part of this process, if expected content isn't available, then alternative object content could be displayed, as defined in the interface code. For example, if a request resource isn't available, an alternative resource and/or an error message could be presented, allowing exception handling to be performed.

In order to allow the interface pages to be generated in a simple manner, whilst incorporating object content, the interface code typically defines a template for at least one interface page, with the method including generating the next user interface page by populating the template using the required object content. This allows the required object content to be presented in a particular manner thereby simplifying the meaning. This could include for example breaking the object content down into separate items which are then presented audibly in a particular sequence or laid out in a particular manner on a simplified visual interface.

In one particular example, the object content can include a number of content items, such as icons or the like, which may be difficult for a visually impaired user to understand. In order to address this, the interface application can be adapted to identify one or more interface items corresponding to at least one content item using the interface code and then generate the next interface page using the interface item. Thus, content items that are difficult to present audibly can be substituted for more understandable content, referred to as interface items. For example, an icon showing a picture of a train could be replaced by the word train which can then be presented in audible form.

In one example, as content pages may take time to generate, for example if additional content has been requested from a content server, an audible cue can be presented while the interface page is created, thereby alerting the user to the fact that this is occurring. This ensures the user knows the interface application is working correctly and allows the user to know when to expect the next interface page to be presented.

The interface pages can be arranged hierarchically in accordance with a structure of the content. For example, this allows interface pages to be arranged so that each interface page is indicative of a particular part of a task, such as a respective interaction and one or more associated user input options, with the pages being presented in a sequence in accordance with a sequence of typical user interactions required to perform a task. This can include presenting one or more initial pages to allow the user to select which of a number of tasks should be performed, then presenting separate pages to complete the task. It will be appreciated that this assists in making the content easier to navigate.

In one example, the process of presenting interface pages involves determining the selection of one of a number of interaction response options in accordance with user input inputs and then using the selected interaction response option to select a next interface page or determine the browser instruction to be generated.

Thus, it will be appreciated from the above that the interface code controls the manner and order in which interface pages are presented and the associated actions that are to be performed. The interface code also specifies how the browser is controlled, which can be achieved by having the interface code define the browser instructions to be generated, in one example, defining a respective browser instruction for each of a number of response options. This could be achieved by having the interface code include a script for generating the browser instructions, or could include scripts defining the browser instructions, which form part of the interface code and can simply be transferred to the browser as required. Thus all browser instructions required to interact with the content are defined within the interface code, meaning the interface application is able to generate an appropriate instruction for any required interaction.

The user interface is typically presented audibly and/or visually. If presented visually, this is typically presented in a visually simplified form, which can involve using a single colour font on a different and contrasting single colour background, such as a dark font on a light background, a light font on a dark background, a high contrast font and/or using an oversized font. This technique makes it relatively easy for a visually impaired person to view the interface.

Further details of the above described content presentation process are described in copending application WO2018/132863, the contents of which is incorporated herein by cross reference.

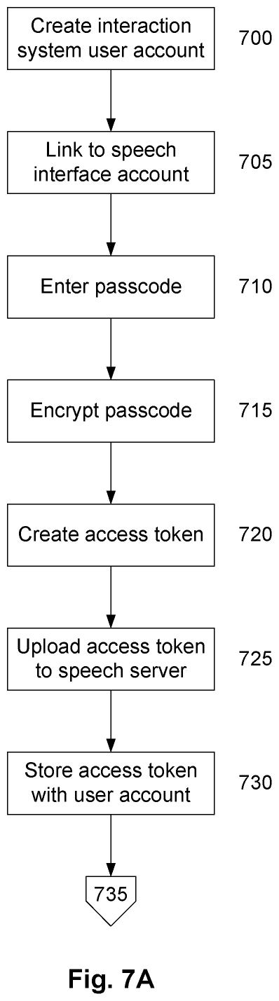

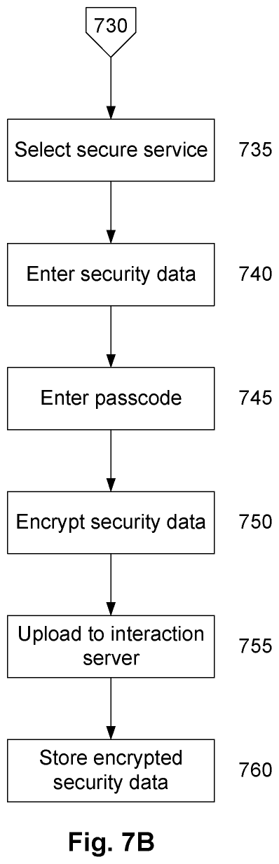

An example of a process for creating security data that can be used to interact with a secure service will now be described with reference to FIGS. 7A and 7B. For the purpose of this example, the process is broken into two stages, namely linking a user account associated with the interface server 510.1, such as a Google Account, with a user account associated with the interaction server 510.2. Following this linking process, described in steps 700 to 735, security data can then be created for accessing one or more secure services, as described in steps 735 to 760.

In this example, at step 700, an interaction system user account is created. This will typically involve having the user utilise the client device 530.2 to provide user details, such as a username, password, billing information, contact information, user preferences, or the like. This can be achieved by access a webpage hosted by the interaction server 510.2 or by using a dedicated application executed by the client device 530.2. Once created, details of the user account are stored in the interaction database 511.2.

At step 705, the interface system user account, such as a Google account, or similar is linked to the interaction system user account. This is typically achieved by using a respective application executed by the client device 530.2, such as the Google Home app, and then using this to create a linking request. This causes the interface and interaction servers 510.1, 510.2 to communicate and link the accounts. This is performed in accordance with known techniques and will not therefore be described in any further detail.

During this process, the user enters their passcode at step 710, with this being provided to the interaction server 510.2. The interaction server 510.2 encrypts the passcode at step 715, using the interaction server public key, so this can only be decrypted by the interaction server 510.2, using the interaction server private key. The interaction server 510.2 then generates a modified (enhanced) OAuth access token at step 720, with the access token including the encrypted PIN as a payload.

At step 725, the access token is uploaded to the speech server 510.1 and stored associated with the interface system user account at step 730, typically by storing this in the database 511.1.

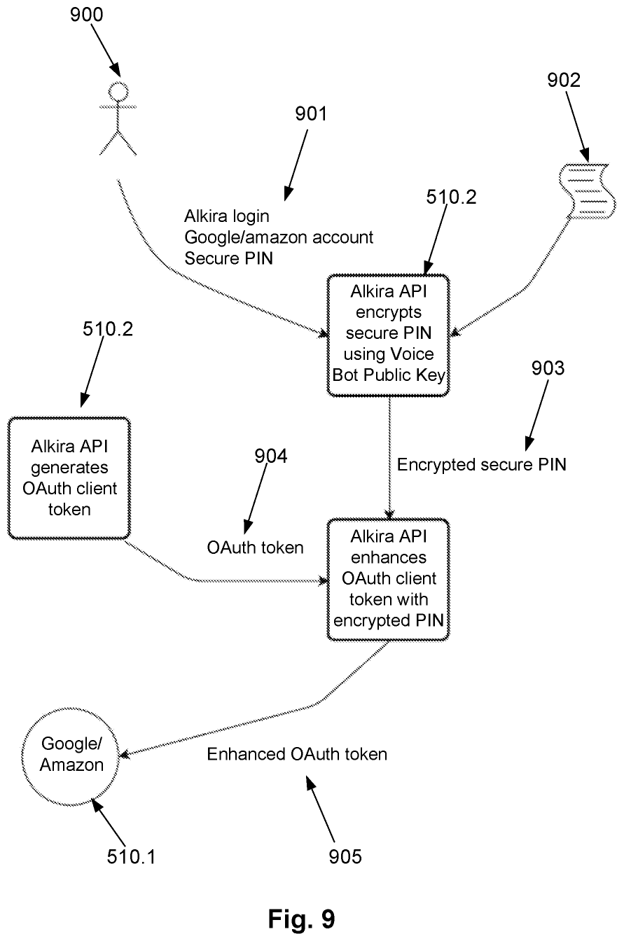

An example of this linking process is also shown schematically in FIG. 9.

In this example, the user 900 uses a web browser or app to nominate to link their interface system user account, (herein their “Google/Amazon account”), to their interaction system account (herein their “Alkira account”). As part of this, the user will nominate their Google/Amazon account and enter their interface account login details (herein their “Alkira Login”) and Secure Pin at 901. These details are uploaded to the interaction server 510.2 (herein “Voice Bot”), which uses an API (herein “Alkira API”) to encrypt the secure PIN using a Voice Bot public key 902 to generate an encrypted secure PIN 903. The Alkira API also generates an OAuth token 904, and uses this together with the encrypted PIN to generate an Enhanced OAuth token 905, which is transferred to the Google/Amazon interaction server 510.2.

Having linked accounts, in a separate process, the user can select a secure service and store security data. In this example, at step 735, the user selects a secure service for which security data is to be provided. This can be achieved in any appropriate manner, and could involve having the interaction server 510.2 provide details of one or more available secure services, allowing these to be presented to the user via the client device 530.2. Alternatively, the user can provide details of a secure service via the client device 530.2, for example by providing a URL associated with the secure service.

Following this, at step 740, the user can enter security data utilising the client device 530.2, in particular, providing any information required to access the secure service, such as a username, password, or other login details, payment details, or the like. At step 745, the user enters the passcode which was used in establishing the access token as described above with respect to steps 700 to 730.

At step 750, security data is encrypted using the passcode and transferred from the client device 530.2 to the interaction server 510.2 at step 755.

At step 760, the interaction server 510.2 receives the encrypted security data storing the encrypted security data in the interaction database 511.2, for example as part of, or otherwise associated with the user account.

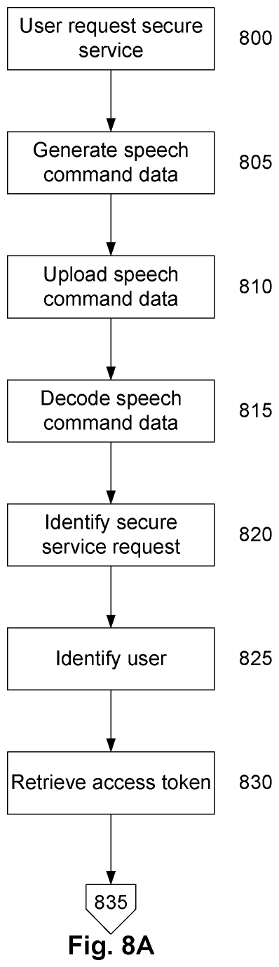

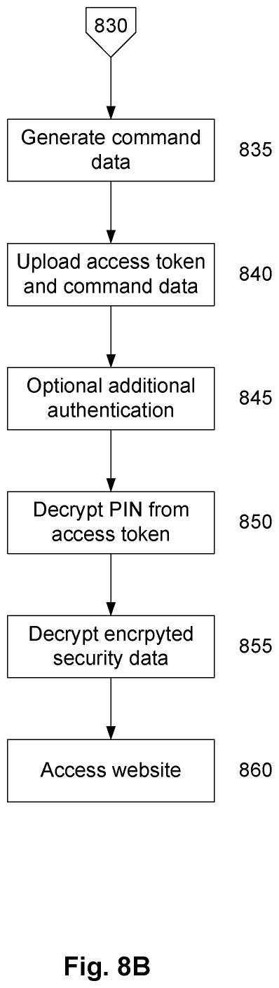

An example of a process for performing an interaction with a secure service will now be described with reference to FIGS. 8A and 8B.

In this example, it is assumed that user interaction is performed via the speech enabled client device 530.1. Accordingly, at step 800, the user requests access to secure service, typically by vocalising a request to the speech enabled client device 530.1 and identifying the secure service that is requested, for example by stating “<Trigger phrase>, tell the interaction server to access my bank account”.

The speech enabled client device 530.1 generates speech input data indicative of the captured audible inputs at step 805, with this being uploaded as speech input data to the speech server 510.1 at step 810. The speech server decodes the speech input data at step 815, and in particular processes the speech input data and uses this to identify the particular words spoken by the user. It will be appreciated that this is performed using known voice recognition techniques, and this will not therefore be described in any further detail.

Having identified the particular combination of words spoken, the speech server 510.1 will analyse the words and determine a secure service request has been made. This will typically involve accessing an application provided by the interaction server 510.2, which instructs the speech server 510.1 as to the form of phrase that corresponds to a secure service request.

As identification of the user is required in order to access the secure service, the speech server 510.1 performs an identification process at step 825. This typically involves using a combination of factors, including voice pattern recognition and information regarding the speech enabled client device 530.1 being used in order to verify an identity of the user. It will be appreciated that in some examples, this might have already been performed earlier in an interaction session, in which case this might not be required. Such identification processes are standard operation for the speech server 510.1, and will not be described in further detail.

At step 825, the identity of the user and knowledge of the requested secure service is used by the speech server 510.1 to retrieve the access token associated with the user's interface system user account from the speech database 511.1 at step 830.

Input data indicative of the secure service request is generated by the speech server 510.1, at step 835, with this typically indicating the requested secure service and any other relevant information provided by the user as part of their spoken input. The input data and access token are then uploaded, to the interaction server 510.2 at step 840. It will be appreciated that this process may involves encrypting the input data and access token, for example using the interaction server public key, to thereby maintain security.

The interaction server 510.2 receives and optionally decrypts the input data and access token. At this stage, the interaction server 510.2, can be adapted to perform an additional authentication step, for example to independently verify the identity of the user. This can be performed in any appropriate manner, and may involve have the user respond to a challenge presented via the client device 530.2, submit a passcode, biometric information, or the like. The need for such additional verification may depend on criteria, such as the nature of the secure service or the like. For example, if the secure service is not critical, additional authentication might not be required, whereas if the service is critical, for example if it is performing a banking transaction, then authentication might be required.

Assuming any additional authentication is successful, then at step 850, the interaction server 510.2 decrypts the PIN stored in the access token payload, using the interaction server secret key, and uses the PIN to retrieve and decrypt security data at step 855.

At step 860, the interaction server 510.2 accesses a website hosted by the content server 510.3, using an internal browser application to retrieve content code corresponding to the website of the secure service, and then populate this with the security data, allowing this to be uploaded to the content server 510.3, so that the content server 510.3 can authenticate the user and provide access to the secure service.

Following this, interaction with the secure service can then be performed in accordance with normal interaction process described above with respect to FIGS. 6A to 6B.

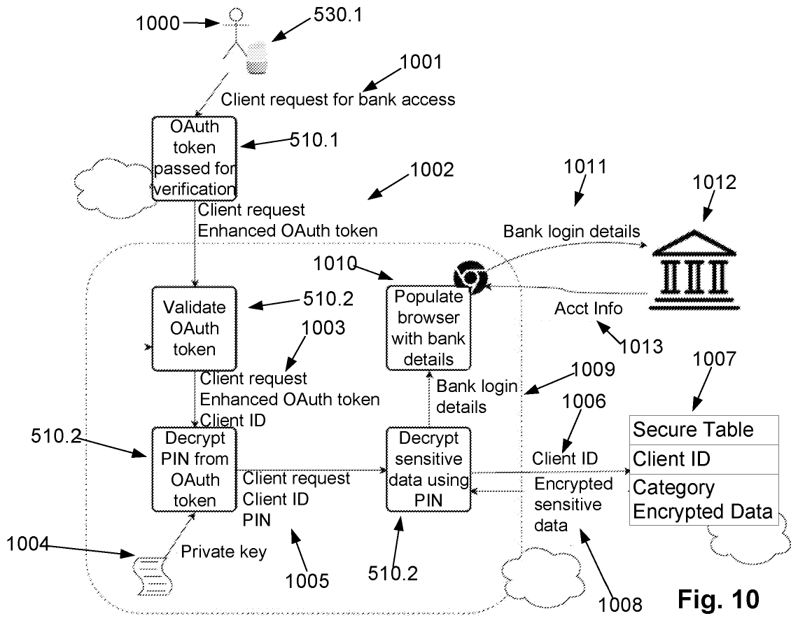

An example of this process is also shown schematically in FIG. 10.

In this example, the user 1000 uses their speech enabled client device 530.1 (herein “Google assistant”) to request access to their bank, with speech command data 1001 indicative of the request being transferred to the speech server 510.1 (herein “Google server”), which uses the Google DialogFlow voice platform to interpret the speech command data and thereby process the request. In particular, the Google server retrieves the modified OAuth token and passes this together with command data 1002 to the Alkira Voice Bot 510.2.

The Alkira Voice Bot 510.2 validates the modified OAuth token to ensure it is valid, and that the user has an Alkira account, thereby determining the command data, pre-linked OAuth token and user ID (herein “Alkira client ID”) 1003. The Alkira Voice Bot then decrypts the secret PIN using the Voice Bot private key 1004, so that it has the command data, Alkira client ID and the secret PIN 1005.

The Alkira Voice Bot uses the Alkira client ID 1006 to retrieve 3rd party details, such as Internet Banking Login details 1008 from a secure setting table 1007 in a database, which is pre-stored as described above with respect to FIGS. 7A and 7B. The Alkira Voice bot then uses the user's secret PIN to decrypt the Internet Banking Login details.

The Alkira Voice Bot uses the Banking login details 1009 to populate an internal browser 1010, which submits a login request, including the Banking login details, 1011 to a bank 1012, allowing requested bank account information 1013 to be retrieved.

Accordingly, it will be appreciated that the above described process allows security data to be securely stored and retrieved as required, in order to allow access to be provided to secure services. This avoids the need for the user to enter sensitive information, such as a username and passcode, at the time at which the service is accessed, instead providing this information a single time during a configuration process. This in turn allows the user to access secure services via a speech interface system, which would not otherwise be achievable in a secure manner.

Throughout the above, where reference is made to specific voice services, such as Google/Amazon, it will be appreciated that this is not intended to be limiting and that in practice the techniques could be applied to the voice services of other service providers.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1. A system for allowing a user to interact with a secure service, the system including an interaction processing system including one or more electronic processing devices configured to:
a) receive security data from a user client device, the security data being usable to interact with the secure service and being encrypted using a passcode;
b) store the security data;
c) receive from a user interface system, on behalf of the user, an indication of:
i) a service interaction request;
ii) an access token indicative of the passcode;
d) retrieve the security data using the access token; and
e) use the security data to interact with the secure service on behalf of the user and in accordance with the service interaction request.

2. A system according to claim 1, wherein the access token contains an encrypted version of the passcode.

3. A system according to claim 2, wherein the passcode is encrypted using an encryption key of the interaction system.

4. A system according to claim 1, wherein the access token is a modified OAuth token.

5. A system according to claim 1, wherein the interaction processing system is configured to:
a) receive the passcode;
b) use the passcode to generate the access token; and,
c) transfer the access token to a user interface system.

6. A system according to claim 5, wherein the interface system is configured to associate the access token with a user identity and wherein the user interface system is configured to:
a) determine a user identity; and,
b) retrieve the access token using the user identity.

7. A system according to claim 6, wherein the interface system is configured to associate the access token with an interface system user account linked to the interaction system user account.

8. A system according to claim 7, wherein the interaction processing system is configured to receive the passcode from an account linking device used to link the interaction system and interface system user accounts.

9. A system according to claim 8, wherein the passcode is provided to the account linking device from the client device during an account linking process.

10. A system according to claim 1, wherein the client device is configured to:
a) determine using user input commands:
i) the security data; and,
ii) the passcode;
b) encrypt the security data using the passcode; and,
c) provide the encrypted security data to the interaction processing system.

11. A system according to claim 1, wherein, in response to receiving the service interaction request, the interaction processing system is configured to:
a) authenticate the user to validate a user identity of the user; and,
b) retrieve the security data in response to successful validation.

12. A system according to claim 1, wherein the interaction processing device is configured to:
a) request secondary security data from the user via the user client device; and,
b) access the secure service at least in part using the secondary security data.

13. A system according to claim 1, wherein the user interface system includes a speech processing system that is configured to:
a) generate speech interface data;
b) provide the speech interface data to a speech enabled client device, wherein the speech enabled client device is configured to be responsive to the speech interface data to:
i) generate audible speech output indicative of a speech interface;
ii) detect audible speech inputs indicative of a user input; and,
iii) generate speech input data indicative of the speech inputs;
c) receive speech input data; and,
d) use the speech input data to at least one of:
i) identify a user; and,
ii) determine a service interaction request from the user.

14. A system according to claim 13, wherein:
a) the speech processing system is configured to:
i) interpret the speech input data to identify a input;
ii) generate input data indicative of the input;
b) the interaction processing system is configured to:
i) obtain the input data;
ii) use the input data to identify a content interaction; and,
iii) perform the content interaction.

15. A system according to claim 13, wherein:
a) the interaction processing system is configured to:
i) obtain content code from a content processing system in accordance with a content address, the content code representing content that can be displayed;
ii) obtain interface code from an interface processing system at least partially in accordance with the content address, the interface code being indicative of an interface structure;
iii) construct a speech interface by populating the interface structure using content obtained from the content code;
iv) generate interface data indicative of the speech interface;
b) the speech processing system is configured to:
i) receive the interface data; and,
ii) generate the speech interface data using the interface data.

16. A system according to claim 1, wherein the security data includes at least one of:
a) a username;
b) a password;
c) payment details; and,
d) account details.

17. A system according to claim 1, wherein the secure service is accessed at least one of:
a) via a website;
b) via an interface to a web service; and,
c) via a third party system.

18. A method for allowing a user to interact with a secure service, the method including, in an interaction processing system including one or more electronic processing devices:
a) receiving security data from a user client device, the security data being usable to interact with the secure service and being encrypted using a passcode;
b) store the security data;
c) receiving from a user interface system, on behalf of the user, an indication of:
i) a service interaction request;
ii) an access token indicative of the passcode;
d) retrieving the security data using the access token; and
e) using the security data to interact with the secure service on behalf of the user and in accordance with the service interaction request.

19. A computer program product for allowing a user to interact with a secure service, the computer program product including computer executable code that when executed by a suitably programmed interaction processing system including one or more electronic processing devices, causes the interaction processing system to:
a) receive security data from a user client device, the security data being usable to interact with the secure service and being encrypted using a passcode;
b) store the security data;
c) receive from a user interface system, on behalf of the user, an indication of:
i) a service interaction request;
ii) an access token indicative of the passcode;
d) retrieve the security data using the access token; and
e) use the security data to interact with the secure service on behalf of the user and in accordance with the service interaction request.
